(19) United States
(12) Patent Application Publication
(10) Pub. No.: US 2024/0100558 A1
(43) Pub. Date: Mar. 28, 2024

(54) COATING DEVICE

(71) Applicant: TORAY ENGINEERING CO., LTD., Tokyo (JP)

(72) Inventors: Kenji HAMAKAWA, Otsu-shi (JP); Hisayoshi TAJIMA, Otsu-shi (JP); Toshifumi ITO, Otsu-shi (JP)

(21) Appl. No.: 18/473,395

(22) Filed: Sep. 25, 2023

(30) Foreign Application Priority Data
Sep. 28, 2022 (JP) 2022-154778

(51) Int. Cl. B05C 9/12; B05D 3/04

(52) U.S. Cl. CPC B05C 9/12; B05D 3/0453; F26B 17/00

(57) ABSTRACT

A coating device is provided with a stage on which a substrate is configured to be placed, an applicator movably arranged relative to the substrate placed on the stage and configured to discharge a coating liquid from a nozzle to form a coating film on the substrate, and a dryer having an air supply port with at least one porous member. The dryer is configured to dry the coating film formed on the substrate by the applicator by supplying air to the coating film from the air supply port. The at least one porous member is configured and arranged to suppress formation of local variations in an amount of air supplied from the air supply port.

### CROSS-REFERENCE TO RELATED APPLICATIONS

This application claims priority to Japanese Patent Application No. 2022-154778 filed on Sep. 28, 2022 with Japan Patent Office. The entire disclosure of Japanese Patent Application No. 2022-154778 is hereby incorporated herein by reference.

### BACKGROUND

### Field of the Invention

The present invention generally relates to a coating device that applies a coating liquid onto a substrate. More specifically, the present invention relates to a coating device that dries the coating liquid immediately after discharge.

### Background Information

Recent years have seen the use of a substrate W on which a uniform thin-film has been formed (referred to as a coated substrate), for various purposes. For example, in forming a coating film of a uniform thickness on a substrate, the film is formed by a coating device having a slit-shaped nozzle. As shown in FIG. 6, this coating device has a stage 100 on which a substrate W is placed, and an applicator 101 having a slit-shaped nozzle from which a coating liquid is discharged. A coating film C of a specific thickness is formed on the substrate W by moving the substrate W and the applicator 101 relative to each other in the coating direction (X axis direction) while discharging the coating liquid from the slit of the nozzle.

Then, the coated substrate W thus formed is dried with a dryer 102 that is separate from the coating device, after being conveyed out of the coating device (see, Japanese Patent Application Publication No. 2010-034309 (Patent Literature 1), for example).

### SUMMARY

However, a problem with the above coating device is that the functionality of the formed coating film C could not be fully exhibited. That is, in recent years, some materials exhibit stable functionality when dried immediately after being applied as the coating film C, as a characteristic of the material. For instance, such materials include materials that have been used for perovskite solar cells. With the above coating device, after the coating film C is formed, it takes time for the film to be transported to a separate dryer 102, and a problem is that this extra time affects the crystalline state of the coating film C, preventing the functionality of the material from being stably exhibited.

In view of this, it is also conceivable to dry the coating film C by blowing air onto the film immediately after its application. That is, as shown in FIG. 7A, a dryer 103 (blower) having a slit-shaped outlet extending in the width direction is used in the same manner as the applicator 101 to blow air onto the formed coating film, thereby allowing the coating film to be dried immediately after it is formed. That is, air is supplied to the entire surface of the coating film C to dry the film by moving the film in the coating direction while blowing air from the dryer 103 onto the film.

However, as shown in FIG. 7B, with this dryer 103, it is difficult to blow the air uniformly in the lengthwise direction, resulting in local unevenness in the amount of air (two-dot chain lines in FIG. 7B). Accordingly, a problem is that the coating film C is affected by the unevenness in the amount of air, which would form streaky unevenness in the coating film C along the coating direction.

It is an object of the present disclosure to provide a coating device with which there is less unevenness in the amount of air supplied by a dryer, and therefore less unevenness in a coating film.

In order to solve the above problem, a coating device of the present disclosure comprises a stage on which a substrate is configured to be placed, an applicator movably arranged relative to the substrate placed on the stage and configured to discharge a coating liquid from a nozzle to form a coating film on the substrate, and a dryer having an air supply port with at least one porous member. The dryer is configured to dry the coating film formed on the substrate by the applicator by supplying air to the coating film from the air supply port. The at least one porous member is configured and arranged to suppress formation of local variations in an amount of air supplied from the air supply port.

With the above coating device, since the at least one porous member is provided at the air supply port of the dryer, air passes through the at least one porous member and the force of the air is reduced, so the air discharged from the air supply port becomes more uniform throughout the entire air supply port, and local fluctuations in the amount of air supply can be suppressed. Consequently, there is less of the unevenness in the amount of air supplied by the dryer encountered in the past, and therefore less unevenness in the coating film.

Also, the configuration may be such that the dryer is provided to the applicator.

With this configuration, the coating liquid is discharged from the applicator, and drying can be started as soon as the coating liquid lands on the substrate.

Also, the configuration may be such that the at least one porous member includes a plurality of porous members that are arranged side by side at the air supply port, and the porous members are arranged relative to each other to avoid formation of joints between adjacent porous members in a way that crosses the air supply port in a straight line in a coating direction in which the applicator moves when forming the coating film.

With this configuration, since air is not supplied at the joints formed between the adjacent porous members, the amount of air supplied at the joints becomes smaller compared to the coating film region immediately below the porous members. Accordingly, when the dryer is moved in the coating direction, the drying state of the coating film directly under the joints is different from that directly under the porous members, resulting in streaky unevenness. However, if the configuration is such that the air supply port is not crossed by the joints in a straight line in the coating direction, then when the dryer moves in the coating direction, the porous members will inevitably pass over a position on the coating film that was directly under a joint, and this prevents streaks from being formed in the coating film.

In a specific embodiment, the at least one porous member is arranged in a plurality of porous array portions in each of which a plurality of porous members are arranged side by side in a width direction perpendicular to a coating direction, the porous array portions are arranged in a plurality of rows in the coating direction at the air supply port, and the porous members in adjacent porous array portions are arranged such that joints between the adjacent porous members in the adjacent porous array portions are prevented from being disposed continuously in the coating direction in the adjacent porous array portions. This configuration avoids the formation of a region in the coating film where the joints always pass in the coating direction, thereby avoiding the formation of streaky unevenness in the coating film.

With the coating device of the present disclosure, it is less likely that there will be unevenness in the coating film because there is less variance in the amount of air supplied by the dryer.

### BRIEF DESCRIPTION OF THE DRAWINGS

FIG. 1 is a perspective view of a coating device according to an embodiment of the present disclosure;

FIG. 2 is a schematic diagram showing the vicinity of a leg portion of a coating unit;

FIG. 3 is a cross-sectional view of an applicator provided with a dryer;

FIG. 4 is a diagram showing a state in which a coating liquid has been discharged from the applicator;

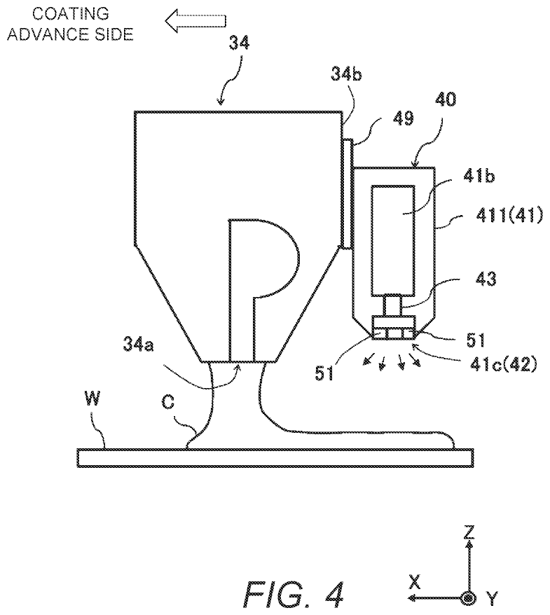

FIGS. 5A, 5B and 5C are diagrams of an air supply port of the dryer, with FIG. 5A being a diagram of a state in which porous plates have been laid in place, FIG. 5B being a diagram of a state in which joints of the porous plates are connected in a straight line, and FIG. 5C being a diagram of a state in which air has been discharged in the state of FIG. 5B;

FIG. 6 is a diagram showing a coating device and a dryer; and

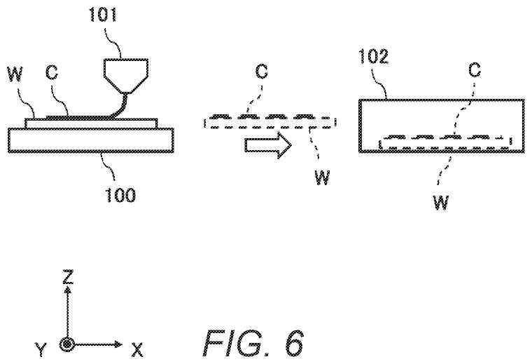

FIGS. 7A and 7B are diagrams showing a state in which air has been discharged from a dryer according to a comparative example, with FIG. 7A being a diagram as seen in a direction perpendicular to the coating direction, and FIG. 7B being a diagram as seen in the coating direction.

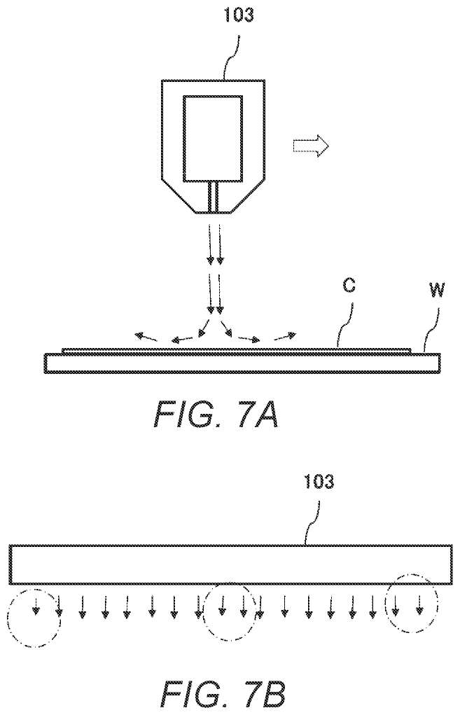

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

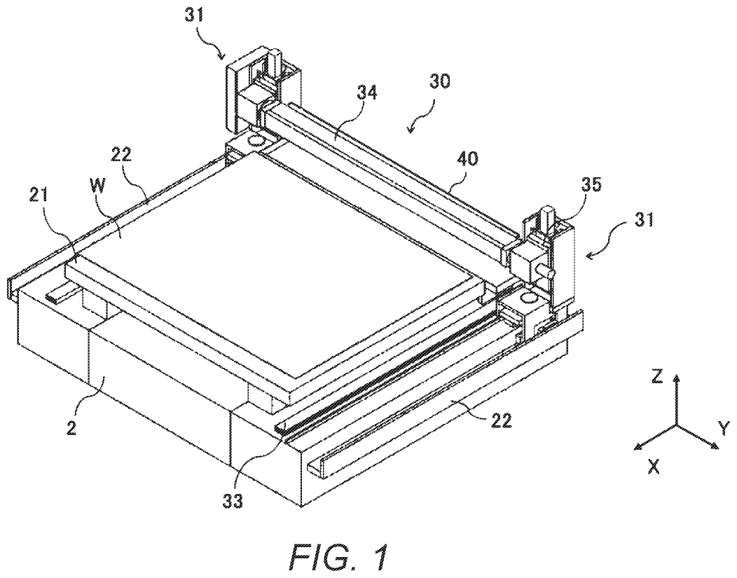

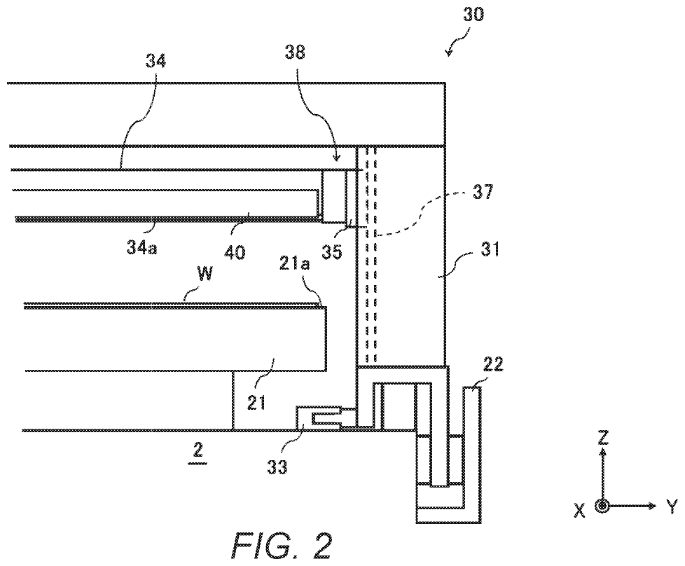

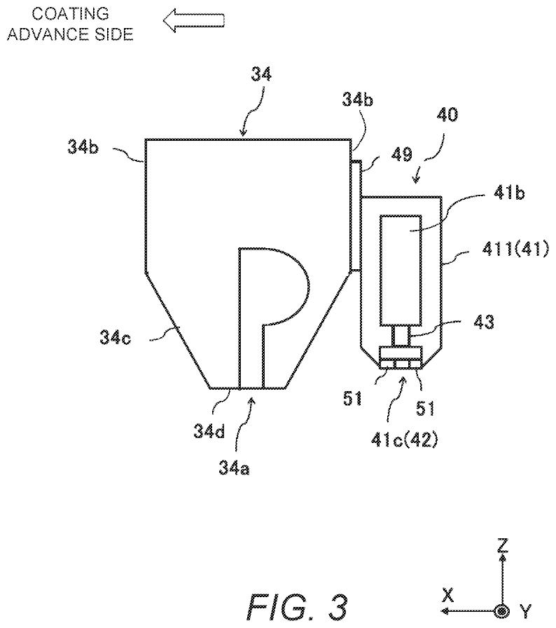

FIG. 1 is a schematic perspective view of a coating device in an embodiment of the present disclosure, FIG. 2 is a diagram showing the vicinity of a leg portion of a coating unit, and FIG. 3 is a cross-sectional view of an applicator provided with a dryer.

As shown in FIGS. 1 to 3, the coating device forms a coating film of a liquid substance, such as a chemical solution or a resist solution, (hereinafter referred to as a coating liquid) on a substrate W. The coating device comprises a base 2, a stage 21 on which the substrate W is placed, and a coating unit 30 configured to be movable in a specific direction with respect to the stage 21.

In the following description, the direction in which the coating unit 30 moves is referred to as the X axis direction, the direction perpendicular to this on the horizontal plane is referred to as the Y axis direction, and the direction perpendicular to both the X axis direction and the Y axis direction is referred to as the Z axis direction.

The stage 21 is disposed in the center portion of the base 2. This stage 21 is used to hold the substrate W that has been brought in. The stage 21 is provided with a substrate mounting surface 21a on which the substrate W is placed, and a substrate holding means (not shown). The substrate W is held by this substrate holding means. More specifically, a plurality of suction holes are formed in the substrate mounting surface 21a of the stage 21, and the substrate W can be drawn to and held against the substrate mounting surface 21a by generating a suction force in these suction holes.

The stage 21 is also provided with a substrate elevating mechanism for moving the substrate W up and down. More specifically, a plurality of pin holes are formed in the surface of the stage 21, and lift pins (not shown) capable of moving up and down in the Z axis direction are embedded in these pin holes. That is, when the substrate W is brought in while the lift pins are protruding from the surface of the stage 21, the tip portions of the lift pins hit the substrate W, allowing the substrate W to be held. The substrate W can be placed on the substrate placement surface 21a by lowering the lift pins from this state and retracting them into the pin holes.

The coating unit 30 discharges the coating liquid onto the substrate W to form a coating film C. As shown in FIGS. 1 and 2, the coating unit 30 has leg portions 31 linked to the base 2, and an applicator 34 extending in the Y axis direction, and is attached so as to be movable in the X axis direction while straddling the base 2 in the Y axis direction. More specifically, rails 22 extending in the X axis direction are installed at the ends of the base 2 in the Y axis direction, and the leg portions 31 are slidably attached to the rails 22. A linear motor is attached to the leg portions 31, and the coating unit 30 can be moved in the X axis direction and stopped at the desired position by driving and controlling this linear motor.

Also, as shown in FIG. 2, the applicator 34 for applying the coating liquid is attached to the leg portions 31 of the coating unit 30. More specifically, the leg portions 31 are provided with rails 37 extending in the Z axis direction, and sliders 35 that slide along the rails 37, and these sliders 35 and the applicator 34 are linked. A ball screw mechanism driven by a servomotor is attached to the sliders 35, and the sliders 35 can be moved in the Z axis direction and stopped at the desired position by controlling the drive of this servomotor. That is, the applicator 34 is supported so as to be able to come into contact with and move away from the substrate W held on the stage 21.

As shown in FIGS. 1 to 3, the applicator 34 forms a coating film C on the substrate W by discharging the coating liquid. This applicator 34 is a columnar member having a shape extending in one direction, and is provided so as to be substantially perpendicular to the direction in which the coating unit 30 moves. The applicator 34 has side surface portions 34b extending in the vertical direction, and has a substrate opposing surface 34d that is opposite the substrate W via inclined surface portions 34c formed in an inclined shape from the side surface portions 34b. A slit nozzle 34a is formed in the substrate opposing surface 34d, and the coating liquid is discharged from the slit nozzle 34a. That is, the slit nozzle 34a is formed on the substrate opposing surface 34d of the applicator 34 so as to extend in the lengthwise or width direction (i.e., the Y direction), and the coating liquid supplied to the applicator 34 is discharged uniformly in the lengthwise direction from the slit nozzle 34a. Therefore, when the coating unit 30 is moved in the X axis direction while the coating liquid is discharged from the slit nozzle 34a, a coating film C of a constant thickness is formed on the substrate W along the lengthwise direction of the slit nozzle 34a. In this embodiment, the direction in which the coating unit 30 is moved while the coating liquid is being discharged from the slit nozzle 34a is referred to as a coating direction, and the coating direction side is referred to as a coating advance side.

The applicator 34 is also provided with a dryer 40. This dryer 40 dries the coating film C formed on the substrate W. Here, the term “drying” does not only mean complete drying, but also encompasses drying to a semi-dry state and drying to the extent that crystallization of the material is accelerated compared to natural air drying.

In this embodiment, the dryer 40 is integrally attached to the applicator 34 so as to be adjacent to the opposite side from the coating advance side. That is, when the applicator 34 moves in the coating advance direction while discharging the coating liquid, the dryer 40 moves integrally with the applicator 34, and immediately after the coating film C is formed on the substrate W, the coating film C is dried by the dryer 40. In other words, the dryer 40 is disposed upstream of the applicator 34 in the coating direction.

The dryer 40 is provided along the lengthwise direction of the applicator 34 and has a blower 41 for supplying air. In this embodiment, the blower 41 is disposed and configured so as to be adjacent to the applicator 34.

The blower 41 is used to supply air to the coating film C formed on the substrate W. In this embodiment, the blower 41 has a blower main body 411 and an air discharge unit 42, and the air held in the blower main body 411 is blown out through the air discharge unit 42.

The blower main body 411 has a box shape and is formed in a shape extending in the lengthwise direction along the side surface portion 34b of the applicator 34. In this embodiment, the blower main body 411 is formed so as to be longer than the slit nozzle 34a. Also, the blower main body 411 is provided with a cavity 41b for holding air to be supplied to the coating film C, and the air supplied from an air supply source (not shown) can be temporarily held in this cavity 41b. The cavity 41b is formed in a shape extending in the lengthwise direction, and is connected to and communicates with the air discharge unit 42 by means of a communication channel 43 formed narrower than the cavity 41b. Therefore, when air is supplied to the cavity 41b, the air spreads out into the entire cavity 41b and is temporarily held there, and then passes through the narrow communication channel 43, so that the air is supplied to the air discharge unit 42 uniformly along the lengthwise direction.

The air discharge unit 42 is used to guide the air supplied by the blower main body 411 to the coating film C. The air discharge unit 42 has an air supply port 41c through which air is discharged, and the air supply port 41c is formed at a height position so as to extend to near the slit nozzle 34a. In the example in FIG. 3, the air supply port 41c extends to a position slightly higher than the height position of the slit nozzle 34a, that is, to a height position where there will be no contact with the coating film C formed on the substrate W. The cavity 41b of the blower main body 411 and the air supply port 41c of the air discharge unit 42 are connected by the communication channel 43. That is, when the air supply source is actuated, the air discharge unit 42 can guide the air in the cavity 41b to the air supply port 41c through the communication channel 43.

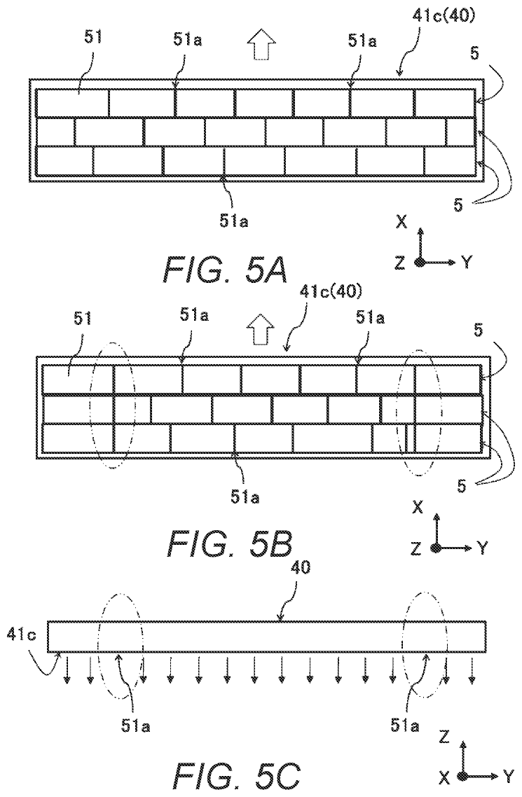

Also, the air discharge unit 42 accommodates a plurality of porous plates 51. These porous plates 51 are formed of porous members formed into a flat plate shape. In this embodiment, as shown in FIG. 5A, a plurality of rectangular porous plates 51 are arranged side by side at the air supply port 41c, which is formed in a rectangular shape. Thus, in the illustrated embodiment, the air supply port 41c has a rectangular shape as viewed in the vertical direction (i.e., the Z direction), while the porous plates 51 have a rectangular shape as viewed in the vertical direction. More specifically, three rows of porous array portions 5 extending in the lengthwise direction of the air supply port 41c are provided, and a plurality of porous plates 51 are disposed next to each other in the lengthwise direction in each porous array portion 5. These porous plates 51 are connected to each other by adhesive members, for example, and the plurality of porous plates 51 are arranged side by side in the lengthwise direction in each porous array portion 5. That is, the air supply port 41c is formed by packing the plurality of porous plates 51 therein so there are no gaps between them. In other words, the porous plates 51 are arranged to cover the air supply port 41c. The dryer is configured to supply the air from the air supply port 41c through the porous plates 51. In the illustrated embodiment, the porous plates 51 are made of any suitable materials, such as carbon materials, metallic materials, ceramic materials, polymetric materials, etc. More specifically, the porous plates 51 are made of carbon, stainless steel, ceramics, Polytetrafluoroethylene (PTFE), etc.

Consequently, the air supplied from the cavity 41b and through the communication channel 43 passes through the porous plates 51 at the air supply port 41c, so the amount of air supplied is made uniform. That is, the porous plates 51 have a large number of randomly formed pores, and the supplied air passes through these pores on the way to the substrate W side. Therefore, since it is less likely that the supplied air will pass through the air supply port 41c in a straight line, the air is less likely to be discharged directly onto the substrate W, which reduces local variance in the air supply amount in the lengthwise direction of the air supply port 41c.

Also, the blower 41 is connected to the applicator 34 and an elevating member 49, allowing the height of the applicator 34 to be adjusted in the Z direction. In other words, the height of the air supply port 41c of the dryer 40 is adjustable relative to the applicator 34. That is, the air supply port 41c can be displaced so as to make contact with or move away from the coating film C that is formed, and the distance between the coating film C and the air supply port 41c can be adjusted. Consequently, the air discharged from the porous plates 51 will be air that is close to the static pressure film and has no directivity, so the height position of the blower 41 can be adjusted by the elevating member 49 so as to make this air act on the coating film C.

Also, the porous plates 51 forming the porous array portions 5 are arranged so that the joints 51a formed between adjacent porous plates 51 do not cross the air supply port 41c in a straight line in the coating direction. That is, the joints 51a are formed between adjacent porous plates 51, and these joints 51a either have a portion that is not formed by the porous members, such as an adhesive member or a frame that holds the porous members, or, even if these are formed by the porous members, they are formed such that the uniformity of the porous members is rougher than that in the central portion. When the joints 51a are arranged in a straight line in the coating direction at the air supply port 41c as encircled by the two-dot chain lines in FIG. 5B, a region in which not enough air is supplied ends up being formed in a straight line. That is, as shown in FIG. 5C, the joint 51a portions are supplied with less air than the other parts of the porous plates 51, so when these joint 51a portions move in the coating direction, the regions of the coating film C corresponding to the joint 51a portions are not dried as well as other regions. Accordingly, when the joint 51a portions move in the coating direction, this region that is not dried as well ends up being formed in a straight line in the coating direction, which is a problem in that streaky unevenness is produced in the coating film C. Therefore, in this embodiment, the porous plates 51 are disposed such that the joints 51a do not cross the air supply port 41c in a straight line.

More specifically, as shown in FIG. 5A, the porous plates 51 are adjusted for size and arrangement such that joints 51a between the porous plates 51 of the adjacent porous array portions 5 are not aligned in a straight line in the coating direction. In the illustrated embodiment, the porous plates 51 are arranged relative to each other in a zigzag pattern. In particular, the porous plates 51 in each of the rows (e.g., the porous array portions 5) are offset from the porous plates 51 in an adjacent row in the lengthwise or width direction (i.e., the Y direction). Consequently, when air is supplied while the dryer 40 moves in the coating direction, air is always supplied to the coating film C from the porous plates 51 of one of the porous array portions 5, which means that this avoids the problem of streaky unevenness attributable to the formation of regions to which no air is supplied.

As long as the joints 51a of adjacent porous plates 51 are not provided so as to cross the air supply port 41c from end to end in a straight line in the coating direction, it is acceptable for the joints 51a to be connected in a straight line since air will be supplied from the other porous plates 51 so long as the joints 51a are partially continuous in the coating direction.

As discussed above, with this coating device, since the porous members are provided at the air supply port 41c of the dryer 40, the air passes through the porous members and its momentum is reduced, so the air discharged from the air supply port is made uniform over the entire air supply port, and local variance in the amount of air supply can be reduced. As a result, there is less variance in the air supply amount than in the past, and the problem of inconsistency in the coating film can be avoided.

In the above embodiment, an example is given in which the dryer 40 is attached to the applicator 34, but the configuration may be such that the applicator 34 is provided independently from the coating unit 30, and the dryer 40 is driven and the coating film C is dried immediately after the coating film C has been formed on the substrate W by moving the coating unit 30.

Also, in the above embodiment, an example is given in which the porous array portions 5 are provided in three rows, but there may be three or more rows of the porous array portions 5. Preferably, two or more rows of the porous array portions 5 are provided so that the joints 51a of the porous plates 51 between the adjacent porous array portions 5 do not cross the air supply port 41c from end to end in a straight line in the coating direction.

In the above embodiment, an example is given in which the air supplied from the blower 41 is at the temperature of the air supply source (the temperature of the space in which the coating device is installed), but a heater may be provided between the air supply source and the blower 41 so that air heated by the heater is supplied. For instance, if the temperature is set to about 35° C. to 45° C., which is slightly higher than the temperature of the space where the coating device is installed, the drying of the coating film C can be accelerated over that when the air from the air supply source is used without being heated.

Also, in the above embodiment, an example is given in which a plurality of porous array portions 5 are disposed in the coating direction at the air supply port 41c of a single blower 41, but the configuration may be such that blowers 41 are arranged in a plurality of rows in the coating direction, so that the porous array portions 5 are arranged in a plurality of rows. When a plurality of blowers 41 are thus used, the number of porous array portions 5 provided to each blower 41 may be one or more, or a combination of these may be used.

In the above embodiment, an example is given in which the applicator 34 has the slit nozzle 34a, but there are no particular restrictions on the discharge method so long as the applicator (such as an inkjet) moves in one direction and requires drying immediately after the formation of the coating film C.

Also, in the above embodiment, an example is given in which the present disclosure is applied to a coating device in which the substrate W is placed and fixed on the stage 21, but the present disclosure may also be applied to a coating device in which the substrate W is placed on the stage 21 in a state in which the substrate W has been floated up from the stage 21.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a coating device in an upright position on a horizontal surface. Accordingly, these directional terms, as utilized to describe the coating device should be interpreted relative to a coating device on a horizontal surface.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A coating device, comprising:
a stage on which a substrate is configured to be placed;
an applicator movably arranged relative to the substrate placed on the stage and configured to discharge a coating liquid from a nozzle to form a coating film on the substrate; and
a dryer having an air supply port with at least one porous member, the dryer being configured to dry the coating film formed on the substrate by the applicator by supplying air to the coating film from the air supply port, with the at least one porous member being configured and arranged to suppress formation of local variations in an amount of air supplied from the air supply port.

2. The coating device according to claim 1, wherein
the dryer is provided to the applicator.

3. The coating device according to claim 1, wherein
the at least one porous member includes a plurality of porous members that are arranged side by side at the air supply port, and
the porous members are arranged relative to each other to avoid formation of joints between adjacent porous members in a way that crosses the air supply port in a straight line in a coating direction in which the applicator moves when forming the coating film.

4. The coating device according to claim 1, wherein
the at least one porous member is arranged in a plurality of porous array portions in each of which a plurality of porous members are arranged side by side in a width direction perpendicular to a coating direction at the air supply port,
the porous array portions are arranged in a plurality of rows in the coating direction at the air supply port, and
the porous members in adjacent porous array portions are arranged such that joints between adjacent porous members in the adjacent porous array portions are prevented from being disposed continuously in the coating direction in the adjacent porous array portions.

5. The coating device according to claim 2, wherein
the at least one porous member includes a plurality of the porous members that are arranged side by side at the air supply port, and
the porous members are arranged relative to each other to avoid formation of joints between adjacent porous members in a way that crosses the air supply port in a straight line in a coating direction in which the applicator moves when forming the coating film.

6. The coating device according to claim 2, wherein
the at least one porous member is arranged in a plurality of porous array portions in each of which a plurality of porous members are arranged side by side in a width direction perpendicular to a coating direction at the air supply port,
the porous array portions are arranged in a plurality of rows in the coating direction at the air supply port, and
the porous members in adjacent porous array portions are arranged such that joints between adjacent porous members in the adjacent porous array portions are prevented from being disposed continuously in the coating direction in the adjacent porous array portions.

7. The coating device according to claim 1, wherein
the dryer is disposed upstream of the applicator in a coating direction in which the applicator moves when forming the coating film to dry the coating film subsequent to the applicator forming the coating film on the substrate.

8. The coating device according to claim 7, wherein
the dryer is movable together with the applicator in the coating direction.

9. The coating device according to claim 7, wherein
the air supply port of the dryer is located higher than the nozzle of the applicator.

10. The coating device according to claim 7, wherein
a height of the air supply port of the dryer is adjustable relative to the applicator.

11. The coating device according to claim 7, wherein
the dryer has a blower with a cavity that communicates with the air supply port via a communication channel that is narrower than the air supply port and the cavity in the coating direction.

12. The coating device according to claim 1, wherein
the at least one porous member includes a plurality of porous members that are arranged side by side at the air supply port.

13. The coating device according to claim 12, wherein
adjacent porous members of the porous members are coupled to each other via joints therebetween.

14. The coating device according to claim 1, wherein
the at least one porous member is arranged in a plurality of rows in each of which a plurality of porous members are arranged side by side at the air supply port.

15. The coating device according to claim 14, wherein
adjacent porous members of the porous members in each of the rows are coupled to each other via joints therebetween.

16. The coating device according to claim 14, wherein
the porous members in each of the rows are offset from the porous members in an adjacent row in a width direction perpendicular to the coating direction.

17. The coating device according to claim 1, wherein
the at least one porous member includes a plurality of porous members that are arranged to cover the air supply port.

18. The coating device according to claim 17, wherein
the air supply port has a rectangular shape as viewed in a vertical direction, and
the porous members have a rectangular shape as viewed in the vertical direction.

19. The coating device according to claim 17, wherein
the porous members are arranged relative to each other in a zigzag pattern.

20. The coating device according to claim 1, wherein
the dryer is configured to supply the air from the air supply port through the at least one porous member.
